(19) United States
(12) Patent Application Publication
(10) Pub. No.: US 2018/0234396 A1
(43) Pub. Date: Aug. 16, 2018

(54) System and method for creating private encrypted browser zones based on one or more parameters

(71) Applicant: TENTA, LLC, Seattle, WA (US)

(72) Inventors: Jesse Aaron Adams, Seattle, WA (US); Christopher Joseph O'Connell, Tucson, AZ (US); Jennifer Marie Catanduanes McEwen, Seattle, WA (US)

(21) Appl. No.: 15/932,242

(22) Filed: Feb. 16, 2018

Related U.S. Application Data
(60) Provisional application No. 62/459,895, filed on Feb. 16, 2017.

(51) Int. Cl. H04L 29/06; H04L 29/12; H04L 12/46; H04L 29/08; G06F 21/60

(52) U.S. Cl. CPC H04L 63/0428; H04L 61/1511; H04L 12/4641; G06F 21/602; H04L 67/28; H04L 63/0272; H04L 67/141

(57) ABSTRACT

System and method for establishing zones of restricted data interaction based on specific user-defined parameters. In an embodiment, a first zone may be established having user-selected parameters for a first type of network traffic such as traffic associated with only other computers located in the United States (as determined by DNS records and the like) and a second zone may be established having user-selected parameters for a second type of network traffic such as network traffic associated with only other computers located with a specific domain (e.g., www.mybusiness.com). In such an established and zoned interaction environment, data that is free to be shared in one zone will not be free to be shared in any other zone. Thus, one may establish a virtual private network (VPN) using encrypted communications for a work session with specific user-selected parameters in establishing various zones of control.

### PRIORITY CLAIM

This application claims the benefit of U.S. Provisional Application No. 62/459,895, entitled “SYSTEM AND METHOD FOR CREATING PRIVATE ENCRYPTED BROWSER ZONES BASED ON ONE OR MORE CRITERIA,” filed Feb. 16, 2017, which is incorporated by reference in its entirety herein for all purposes.

### BACKGROUND

Computing devices, such as mobile phones, tablet computers, laptop computers and desktop computers, are often configured to connect to a computer network to communicate with other computing devices. Such is the case with the Internet and any proprietary internal computing network. Standards have been established that allow communications to be shared by all computing devices in a specific network and to ensure that network traffic is routed correctly. Further, public and private networks may coexist such that computing devices may communicate both within and outside of any private network using a public network, such as the Internet.

An administrator of a private communication network may control how and when outside computing devices may establish a connection as well as when internal devices may establish connections outside of private network. Even though a computing device may be physically separated from a private network, the private network may be extended through the public network in a virtual manner by requiring specific communication protocols and credentials prior to establishing the virtual private connection. Thus, a private network may be extended as a virtual private network through the Internet.

Vulnerabilities and privacy concerns abound when using an established existing virtual private networks. Various applications that use network communications may be given access to data caches and memory of the local computing device and unrelated applications on the client device, despite having no authorization, may access the data caches, memory or even the underlying virtual private network. Such data caches and memory may contain data and meta data that may be sensitive or private, and the virtual private network may contain sensitive or private information and resources. As a simple example, when using a search website, an individual may browse to a page offering solutions to a slightly embarrassing health issue. When the user subsequently browses to a shopping website, an advertisement may appear for the product to cure said embarrassing health issue. Advertising software (either from the shopping website itself, or distributed by a third party) is able to see a browsing history (or other tracking techniques, such as beacons) from the computing device used. There are ways to prevent this, but current solutions typically require a great amount of functionality to be disabled (e.g., cookies, handshakes, and the like), require significant user expertise and add significant user experience complexity.

### BRIEF DESCRIPTION OF THE DRAWINGS

Aspects and many of the attendant advantages of the claims will become more readily appreciated as the same become better understood by reference to the following detailed description, when taken in conjunction with the accompanying drawings, wherein:

FIG. 1 is a diagram of a system for facilitating communications between a computing device and a server computer using a single zone for encrypted communications through a public network according to an embodiment of the subject disclosed herein;

FIG. 2 is a diagram of a system for facilitating communications between a computing device and a group of server computers using a single zone for encrypted communications through a public network according to an embodiment of the subject disclosed herein;

FIG. 3 is a diagram of a system for facilitating communications between a computing device and more than one server computer using more than one zone for encrypted communications through a public network according to an embodiment of the subject disclosed herein;

FIG. 4 is a diagram of a system for facilitating communications between a computing device and more than one group of server computers using more than one zone for encrypted communications through a public network according to an embodiment of the subject disclosed herein;

FIG. 5 is a flow diagram of a method for establishing a zone for encrypted communications through a public network according using one or more specific parameters for identifying other server computers subject to such a created zone to an embodiment of the subject disclosed herein; and

FIG. 6 is a block diagram of the computing device that is suitable for realizing the facilitation of communications depicted in FIGS. 1-4, according to an embodiment of the subject disclosed herein.

### DETAILED DESCRIPTION

The following discussion is presented to enable a person skilled in the art to make and use the subject matter disclosed herein. The general principles described may be applied to embodiments and applications other than those detailed above without departing from the spirit and scope of the detailed description. The present disclosure is not intended to be limited to the embodiments shown, but is to be accorded the widest scope consistent with the principles and features disclosed or suggested herein.

By way of an overview, the subject matter disclosed herein may be directed to a system and method for establishing zones of control for various communications to and from a computing devices based on specific criteria (e.g., parameters) corresponding to a zone of control encompassing similarly-situated network locations. Broadly speaking, when a user of a device engages a networked computing environment of any kind, a great deal of data may be sent from the user's device as well as downloaded to the user's device. These “data interactions” are numerous and may include obvious examples such as requesting specific data from websites (e.g., browsing to a website), but also includes less obvious examples, such as history data, DNS data, GPS location data, cookies, browsing history, search history, phone records, online communications history, and much more. In essence, without any restrictions, any data stored in a device or transiently generated on a device may be taken from the device during any networked computing session.

In this patent application, a browser (or any other common term for a networked computing session GUI) executing on a computing device may establish several zones of restricted data interaction based on specific user-defined parameters. As called hereinafter, the Tenta™ browser is a private encrypted browser that allows a user of the computing device to establish zones that correspond to one or more specific parameters with regard to networked computer interactions. For example, a first zone may be established having parameters for network traffic associated with only other computers located in the United States (as determined by DNS records and the like) and a second zone may be established having parameters for network traffic associated with only other computers located with a specific domain (e.g., www.mybusiness.com). In such an established and zoned interaction environment, data that is free to be shared in one zone will not be free to be shared in any other zone. Thus, one may establish a virtual private network (VPN) using encrypted communications for a work session with a specific domain in the second zone without allowing any browsed website in the first zone to gain access to data within the second zone.

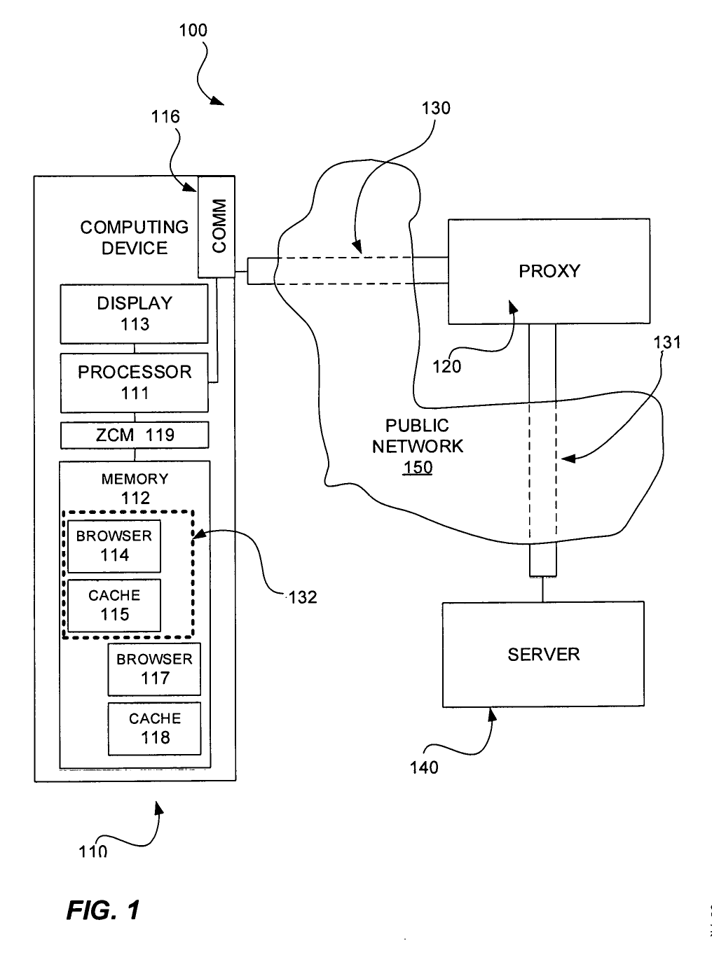

A user may use various parameters for establishing such zones that create one or more so-called, “sandboxes” by which one or more private encrypted browser session may be established. A user may establish zones that isolate data interactions on a zone-by-zone basis. Zones may be established based on one or more parameters and these parameters may be widely varied. For example, a zone may be established by geographic region, top-level domain (e.g., .com, .gov, and the like), destination network (address range, autonomous system number and the like), time of day in which a browsing session is established, relative content of data, specific domain interactions, or any other parameters in which the user may wish to delineate zones. Once zones are established, data interactions within zones are encrypted within the zonal interactions and isolated from any other zone. Each zone may be established with a different encryption key, encryption algorithm, and level of encryption security. Thus, data interactions with an employer's VPN may carry stricter security requirements for encryption in a first zone as compared to common websites in a second zone. These and other aspects are discussed in conjunction with FIGS. 1-6 below.

FIG. 1 is a diagram of a system 100 for facilitating communications between a computing device 110 and a server computer 140 using a single zone 130 for encrypted communications through a public network 150, according to an embodiment of the subject disclosed herein. The computing device 110 may be any computing device capable of electronically communicating with a common public network 150 such as the Internet. The computing device includes a processor 111, a memory, 112, and a display 113. Further, the computing device 110 may be configured to execute an application or set of applications for facilitating communications between the computing device and any remote server computer 140 (e.g., a web server). Various applications and sets of applications may be stored in various logical delineations within the memory 112.

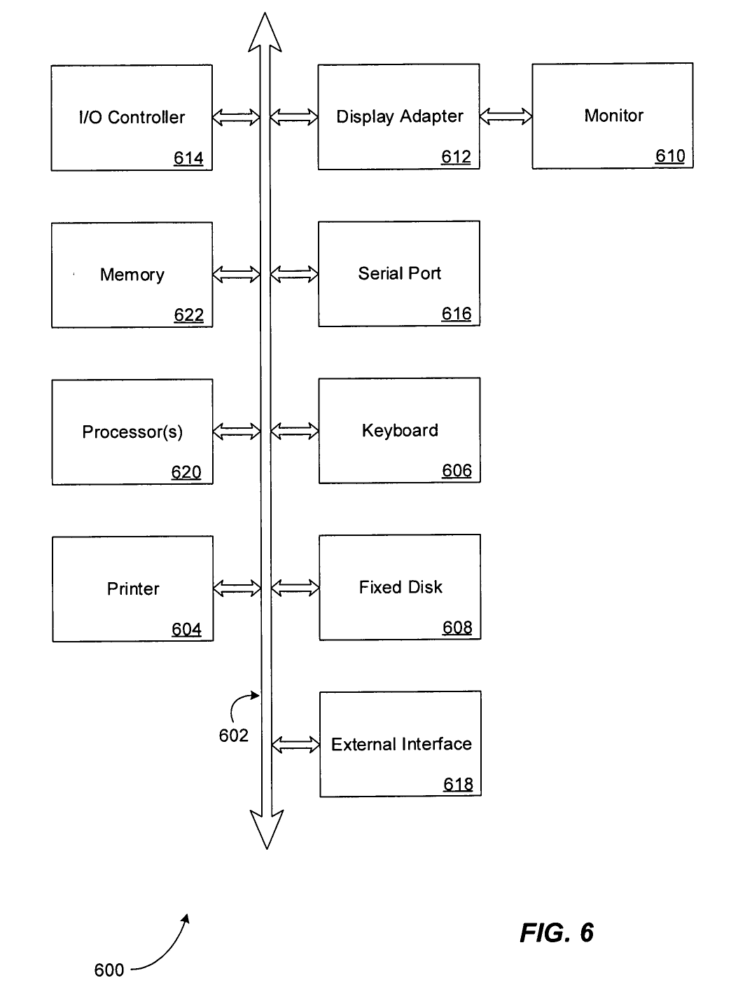

The computing device 110 may include several additional components, as discussed below with respect to FIG. 6. Generally, the computing device may be one or more of: a mobile computing device, a laptop computer, a tablet computing device, a desktop computer, a rack computer, a mobile phone, a personal data assistant, and the like.

Communications may be routed through one or more proxy server computers 120. In computer networks, a proxy server 120 is a server (a computer system or an application) that acts as an intermediary for requests from clients seeking resources from other servers. Clients (such as computing device 110) connect to the proxy server 120 to request some service, such as a file, connection, web page, or other resource available from a different server (such as server 140). The proxy server 120 evaluates the request as a way to simplify and control the interaction, as well as encapsulate and possibly encrypt the data channel. Today, most proxies are web proxies, facilitating access to content on the World Wide Web and providing anonymity, or VPN servers, providing encryption and security.

The computing device 110 may include a browser module 114 (sometimes called a Tenta™ Browser) or related software for web browsing (commonly referred to as a browser) formed according to one or embodiments in this disclosure. Such a browser 114 is a software application for retrieving, presenting, and traversing information resources on a public computer network, such as the Internet. An information resource may be identified by a Uniform Resource Locator (URL) and may be a web page, image, video or other piece of content. A computer language, such as Hypertext Markup Language (HTML), may be used to create web pages with hyperlinks or other navigational methods that enable users to easily access related resources using their browser software. Although browsers primarily access websites on the Internet, they can also be used to access web servers in private networks; files in file systems; data in ephemeral or secret networks, such as Tor; consensus schemes such as blockchains; or distributed schemes such as InterPlanetary File System (IPFS). The browser 114 may have a dedicated cache 115 associated only with this browser 114 realized in the overall memory space 112.

The browser 114 facilitates communication between the computing device 110 and a server computer 140 through a communication module 116 (e.g., a network interface adapter) in the computing device 110. This communication session may be encrypted through use of a virtual private network (VPN) 130. Such a connection is sometimes called a VPN tunnel, as all communications through this communication channel may be encrypted to realize greater security. The VPN 130 may include a second portion 131 that facilitates encrypted communication between a proxy server 120 and a server computer 140. In other embodiments, the communications may be unencrypted to realize the encapsulation benefits of a VPN while still providing transparency for auditing or compliance.

In the Internet addressing architecture, a private network is a network that uses private IP address space, following the standards set by RFC 1918 for Internet Protocol Version 4 (IPv4), and RFC 4193 for Internet Protocol Version 6 (IPv6). These addresses are commonly used for home, office, and enterprise local area networks (LANs). Addresses in the private space are not allocated to any specific organization and anyone may use these addresses without approval from a regional Internet registry. However, IP packets addressed from private networks generally cannot be transmitted through the public Internet. As a result, a private network can only connect to the Internet via a network address translator (NAT) gateway, a proxy server or a router.

There are good and valid reasons why it is often perilous to use addresses outside of the RFC 1918 or RFC 4193 space for a private or internal network. However, the embodiments of the systems and methods described are not restricted to private address space. Instead, any valid IP address may be encapsulated inside the VPN tunnel 130/131. There may be reasons to use such risky addresses, such as to overlay a well-known public IP with an internal version providing a similar service but with different data or privacy guarantees.

Network Address Translation (NAT) is a method of remapping one IP address space into another by modifying network address information in Internet Protocol (IP) datagram packet headers while they are in transit across a traffic routing device. The technique was originally used to ease routing traffic in IP networks without requiring every host to receive a new address. NAT has grown to become a popular and essential tool in conserving global address space allocations due to IPv4 address exhaustion. NAT shares one or a few Internet-routable IP address of a NAT gateway for an entire private network. Computers in a private network may connect to public networks and share communications using network address translation for public network communications. Even when addresses are plentiful, NAT amalgamates all of the communications from devices behind the public IP, making it difficult for other entities on the public network to distinguish between entities behind the NAT.

A VPN 130/131 is a private network that extends across a public network or the Internet 150. It enables users to send and receive data across shared or public networks as if their computing devices were directly connected to a single private network or multiple contiguous private networks. Some VPNs 130/131 allow employees to securely access a corporate intranet while located outside the office. Other VPNs 130/131 can securely connect geographically separated offices of an organization, creating one integrated network. Individual Internet 150 users can use some VPNs 130/131 to secure their transactions while on wireless networks, to circumvent geo-restrictions and censorship, and/or to connect to proxy servers 120 to protect their personal identity and location.

A VPN 130/131 is created by establishing a virtual point-to-point or point-to-multipoint connection through the use of dedicated connections, virtual tunneling protocols, or traffic encryption. A VPN 130/131 available from the public Internet 150 can provide some of the benefits of a wide area network (WAN). A VPN 130/131 user may remotely access the resources available within the private network. A VPN 130/131 facilitates encrypted, authenticated, or encrypted and authenticated communications between computing devices.

Encryption is the process of encoding messages or information so that only authorized parties can read the encrypted contents. Encryption does not prevent interception, but it denies the message content to a would-be eavesdropper. Encryption uses cryptographic algorithms to render a plaintext into a format that is not readable by those who do not possess the decryption key. It is possible to decrypt the message without the key, but unauthorized decryption requires very significant skill and large computational resources. An authorized recipient can easily decrypt the message with the key provided by the sender. An ideal cryptosystem renders the ciphertext indistinguishable from random noise. Practical cryptosystems approach this limit.

Authentication is the process of determining that the actual recipient of the message is the intended recipient. Authentication uses cryptographic algorithms to prove identity and is an important part of establishing a secure connection. Encryption by itself ensures that only the two (or more) parties exchanging messages can read the messages. Authentication ensures that the other parties are the intended recipients, rather than an attacker.

Encryption and authentication provide the strongest protections when combined together. Such combination ensures that information is readable only by the other party (or parties) and that the other party is indeed the desired sender or recipient. Combined encryption and authentication are the most common methods of using cryptography in network communications, however there are some occasions where it may be desirable to use encryption or authentication by themselves.

The combination of encryption and authentication ultimately provides four major modes of operation: (1) unencrypted, (2) encrypted but not authenticated, (3) authenticated but not encrypted, and (4) encrypted and authenticated. Further examples primarily relate to the most common encrypted and authenticated case, but nothing prevents any of these embodiments and systems from working with any of the four modes.

FIG. 1 illustrates a single computing device 110 communicating with one server computer 140 through a single VPN 130/131. This individual VPN 130/131 in FIG. 1 may be designated as a zone of control (or simply “zone”). Zones may be established and facilitated through a Zone Control Module 119. Various zones may be uniquely associated with a specific VPN. In the example of FIG. 1, zone 132 allows communications between the computing device 110 and the server computer 140 in a private encrypted manner through VPN 130/131. The encrypted zone 132 of communications may be isolated from other communications with the computing device 110. Thus, a different browsing session using a different browser 117 (and using a different associated cache 118) may use a non-encrypted, non-private communication path that is isolated from the encrypted zone 132. As a result, communications that utilize the encrypted zone 132 are cached in a memory space 115 not accessible by any other application on the computing device 110. That is, the browser 114 and associated cache 115 are mutually exclusive from the browser 117 and associated cache 118.

A user may permit use of an established zone 132 on an application-by-application basis. For example, a user may configure a cloud music player to utilize a first zone 132 configured to use any local internet connection. A user may also configure a cloud movie player to establish a second VPN using a second zone (for example a zone associated with browser 117 and cache 118) that connects to a second server (not shown in FIG. 1). Thus, setting use of zones through Zone Control Module 119 may be established by a user based upon a user-generated customized distinction among the one or more external computing devices.

Several other delineations of remote servers may be possible. One such distinction is establishing a zone of control based upon a geographic distinction among the one or more external computing devices. For example, websites that are within a user's pre-established geographic region (e.g., a United States server for a United States account), may be designated as part of an established zone of control. A further distinction may be based upon a domain-level logical delineation. For example, the computing device may be established as part of a domain, but operated remotely such that use of a banking application that only connects over a VPN to a network server operated or audited by the bank may realize domain level security.

A user may permit use of a zone 132 on a URL-by-URL basis. A user can establish a custom set of rules for various specified sites. For example, a user provides that website example.com can only be accessed through Zone 1 132. When the user opens the URL example.com/xyz, it will always perform communication in Zone 1 132. As another example, the user can prohibit the saving of any data from a particular domain in one zone 132 while allowing it in another (not shown in FIG. 1). This may be used, for instance, to view a website as a logged in user in one zone 132, while viewing it as a non-logged in user in a different zone (not shown in FIG. 1).

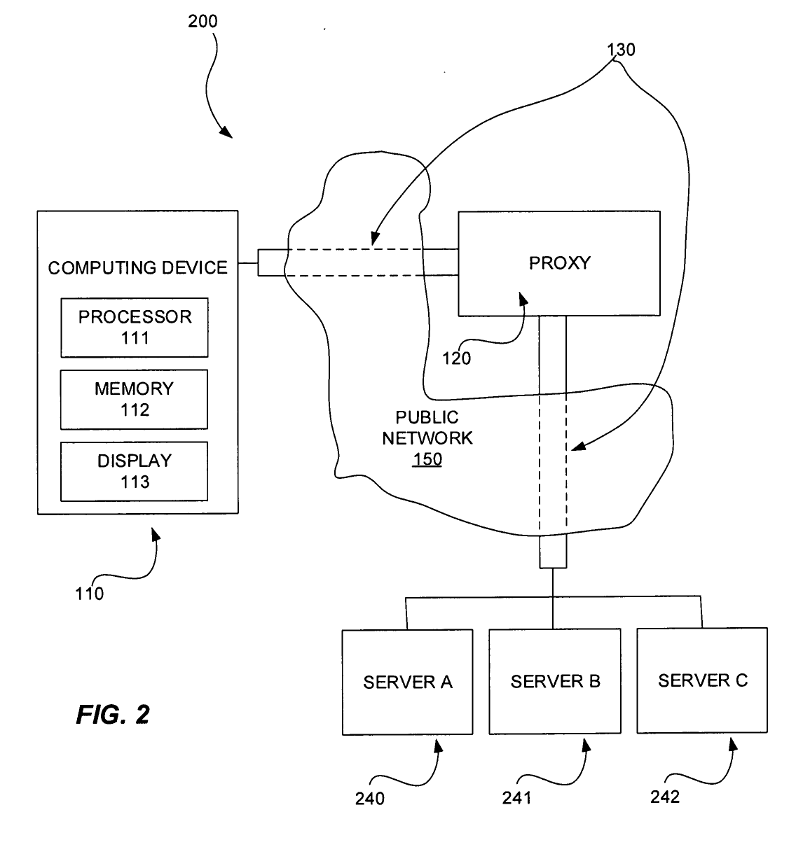

The use of an encrypted VPN 130/132 within a zone of control 132 may be extrapolated to several logical distinctions of communication between the computing device and other remote server computers as is discussed in the example embodiments of FIGS. 2-4 described next.

FIG. 2 is a diagram of a system 200 for facilitating communications between a computing device 110 and a group of server computers 240, 241, and 242 using a single zone 132 for encrypted communications through a public network 150, according to an embodiment of the subject disclosed herein. It is commonly understood that a “server computer” may mean either a single physical server, or a logical grouping of physical servers. For example, multiple physical computers may be used for high availability, disaster recovery, load balancing, and the like. In all of these diagrams, server computer includes either a single physical or virtual computer, or a collection of servers operating as a single logical unit.

A user may configure the use of a zone 132 on a VPN-by-VPN basis. For example, a user establishes permission for communication based on an encrypted (but not authenticated) connection. Alternatively, a user establishes permission based on an authenticated, but not encrypted, connection. That is, the user wishes to make the contents of his communication public (as a matter of free speech, auditing, public record, and the like), but the user also wishes to ensure that the intended party may prove who sent the message. More commonly, a user establishes permission based on an encrypted and authenticated connection.

In the example of FIG. 2, the zone 132 may be established for using the VPN 130/131 to provide encrypted communication to each of the servers 240, 241, and 242. In other embodiments, however, the zone 132 may be established for using the VPN 130/131 to provide encrypted communication to at least one, but less than all, of the servers 240, 241, and 242. In the case of an excluded server (for example server 242), communications may be still occur through VPN 130/131, but communications may not be encrypted in the context of the established zone 132 and any data stored at the computing device will be stored outside of cache 115. Further still, communications to and from an excluded server (server 242 using the previous example) may also occur outside of the VPN 130/131, through a separate communication link not specifically shown in FIG. 2.

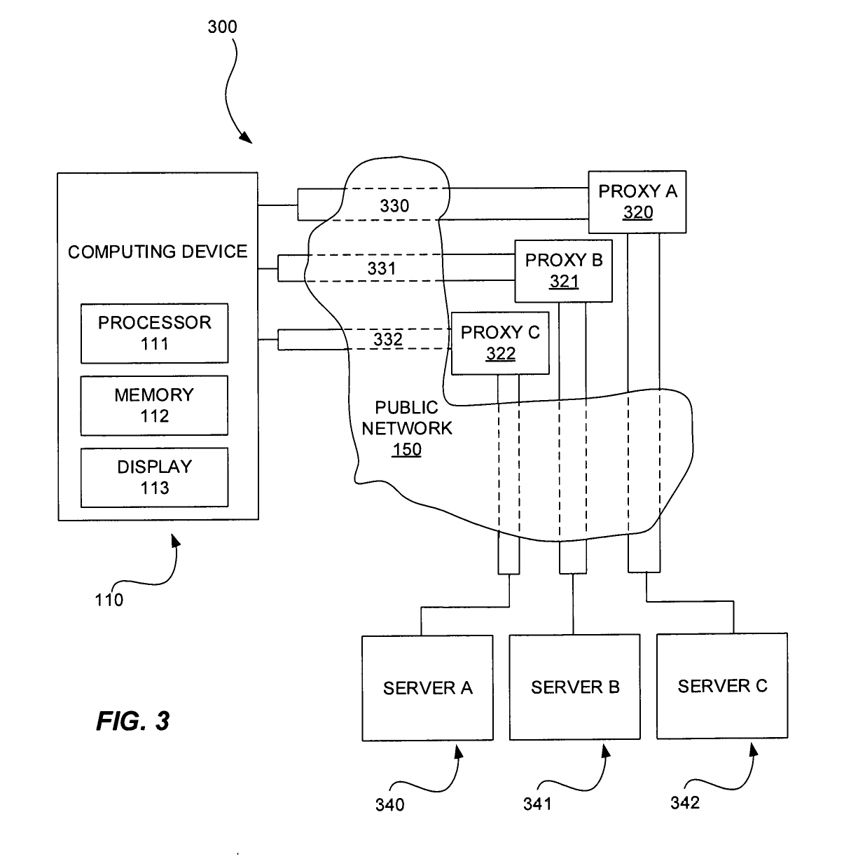

FIG. 3 is a diagram of a system 300 for facilitating communications between a computing device 110 and more than one server computer 340, 341, and 342, using more than one zone 335, 336, and 337 for encrypted communications through a public network 150, according to an embodiment of the subject disclosed herein. In this embodiment, a single computing device 110 may have three separate and discrete encrypted browsing VPN sessions (330, 331, and 332) via three distinct proxies (320, 321, and 322) to three different server computers (340, 341, and 342).

In this manner, a first private encrypted browsing session (with browser 314 and associated cache 315) may be established using a first zone 335 with communications through a first VPN 330 to a first server computer 340. Similarly, a second private encrypted browsing session (with browser 316 and associated cache 317) may be established using a second zone 336 with communications through a second VPN 331 to a first server computer 341. Also similarly, a third private encrypted browsing session (with browser 317 and associated cache 318) may be established using a third zone 337 with communications through a second VPN 332 to a first server computer 342. In this example, each private encrypted session may be isolated from every other private encrypted session. Further, one or more of these sessions may not be private or encrypted.

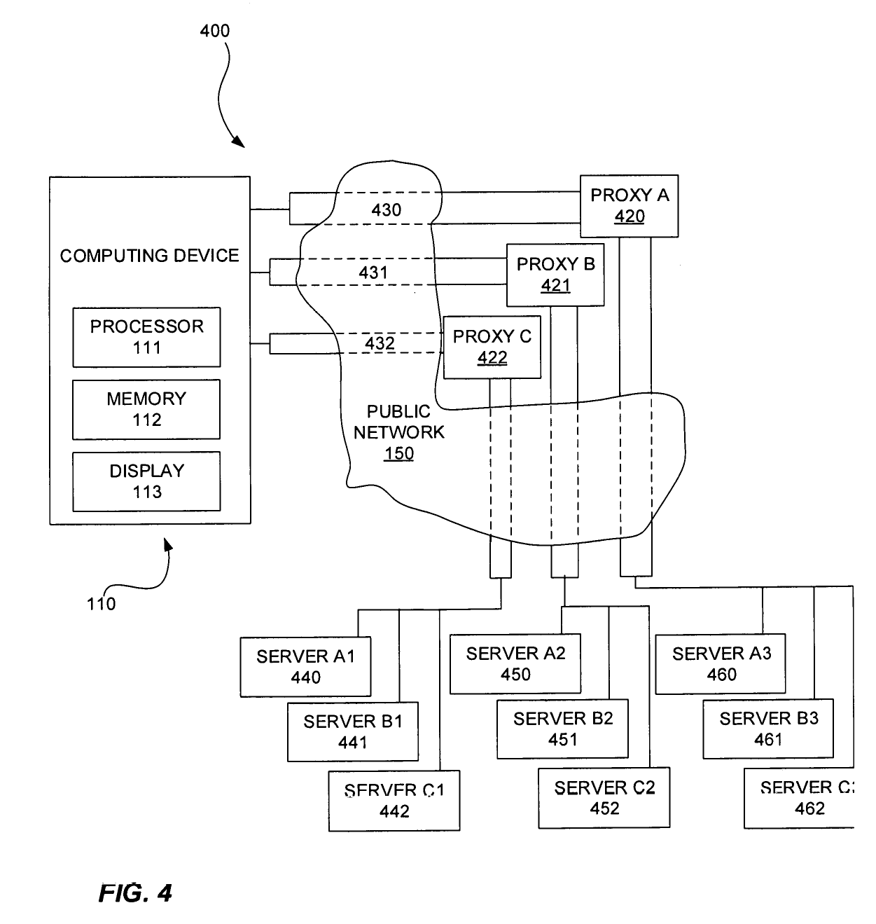

FIG. 4 is a diagram of a system 400 for facilitating communications between a computing device 110 and more than one group of server computers, using more than one zone for encrypted communications through a public network 150, according to an embodiment of the subject disclosed herein. In this embodiment, a single computing device 110 may have three separate and discrete encrypted browsing VPN sessions (430, 431, and 432) using three distinctive zones 435, 436, and 437 via three distinct proxies (420, 421, and 422) to three different groups of server computers; e.g., a first group of server computers (440A, 440B, and 440C), a second group of server computers (441A, 441B, and 441C), and a third group of server computers (442A, 442B, and 442C).

A user may permit use of a zone on a geographical-location-by-geographical location basis. For example, a user may have one zone connected to a server in Seattle and a second zone connected to a server in the UK. Each zone may then have permission rules based on the specific server location, such as only allowing certain types of files or sites to load from that zone.

A user may also permit use based on the sites to which a zone may connect. Thus, a zone connected to a server in the US might only allow US-based sites to connect. Furthermore, a company may establish a zone connected to the company's server in Seattle, then only allow access to sites whitelisted by that company, and only provide access to the company VPN server to employees of the company. More than one zone may be created and more than one set of parameters may be applied to each zone, creating a wide array of possible combinations rules and control.

Although the connections between the computing device, the proxy and the final server are shown as single encrypted links in FIG. 1-4, these links may be made of one or more links on either public or private network, and many such links may be strung together to create logical links.

Although only one proxy server is shown between the computing device and the final server in FIG. 1-4, multiple proxies may be strung together to create longer networks.

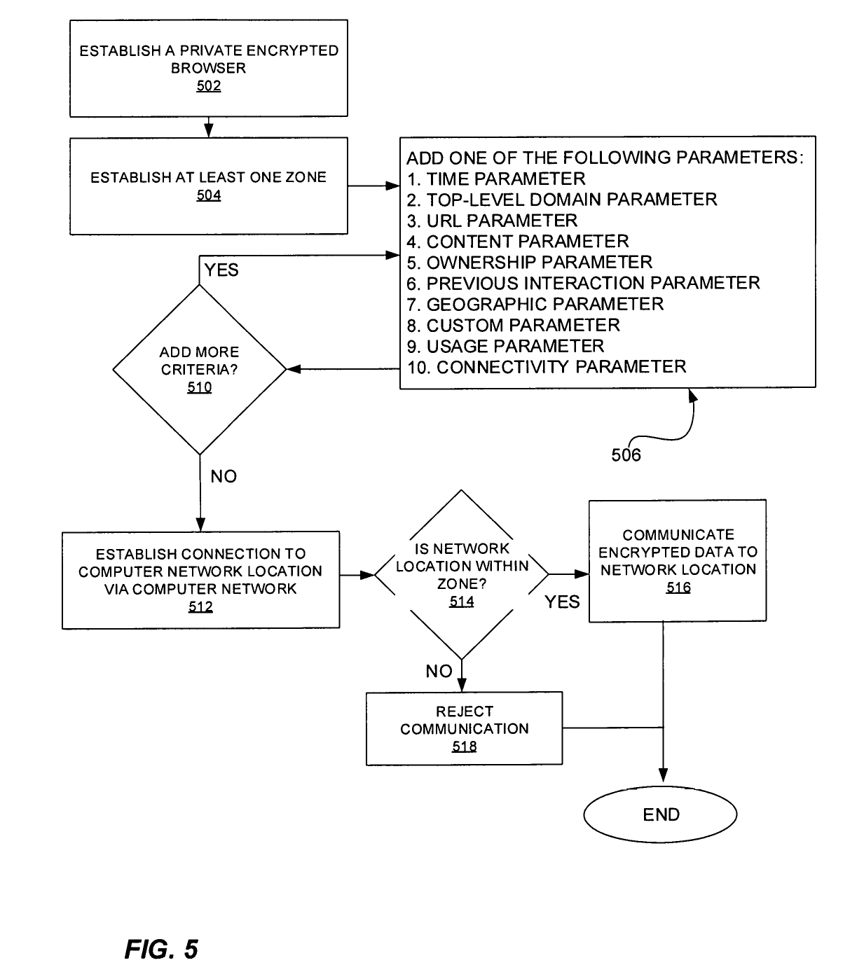

FIG. 5 is a flow diagram of a method for establishing a zone for encrypted communications (e.g., a zone of control) through a public network using specific criteria (e.g., parameters) according to an embodiment of the subject disclosed herein. In particular, various zones of control may be created based on one or more specific parameters about the underlying received data in communications or the source of the data in received communications chosen by a user of the system. As such, a user may establish several different zones of control in which underlying communications and data are isolated from zone to zone wherein data generated by or received within one zone cannot be retrieved, assimilated or otherwise used outside of the established zone of control. As the following examples will show, a user may customize zones by parameter, such as all network traffic from North America, or all network traffic from a popular video service, or all network traffic having a common type of content.

The method may start at step 502 where a private encrypted browser may be instantiated at a local computing device (e.g., mobile phone, laptop computer, or the like) typically owned and operated by a user. The user, having instantiated a private encrypted browsing session, may choose to establish a new zone of control based upon on or more specific parameters at step 504. After one or more specific zones of control have been established, the user may subsequently select a previously-created zone of control to reimplement in the newly instantiated private encrypted browser or the newly instantiated private encrypted browser may already be an established browser with a pre-selected zone of control based on previous establishment. For the purposes of the method of FIG. 5, the method will proceed as if a new set of parameters are to be chosen for establishing a previously unestablished zone of control. As such, the method moves to step 506 for selecting a specific parameter and will back through decision step 508 until the user has selected all specific parameters desired. The specific parameters available for choice in step 506 of the flow chart of FIG. 5 are described next.

In an embodiment, one parameter may be a timestamp parameter. Such a parameter may be based upon a timestamp of when communications are received at the local computing device. That is, the zone of control may established to isolate all communications occurring within period of time having a start time and end time, e.g., all communications between 8 PM and 10 PM as defined by the local time of the local computing device. This allows a user to isolate all network traffic during the specific time such that a browsing session outside of the specific time will not have network traffic subject to the established zone of control. In other embodiments, the timestamp may be based on when the underlying content was created in the communicated data. In still other embodiments, the timestamp may be a local time at the external computing device (e.g., server time) of when the data is sent.

In another embodiment, one parameter may be a top-level domain parameter. Such a parameter is based upon the top-level domain designation of the external computing device network location. Such designation may include .com, .gov, .net, and the like. With this parameter established, network traffic may be isolated within the zone of control to all network traffic from one top-level domain to the exclusion of all other top-level domains.

In another embodiment, one parameter may depend on the network address block (1.2.3.0/24, for example) or autonomous system number (AS123 for example) of either the computing device or the destination network, or both. With this parameter established, network traffic may be isolated within the zone of control to all network traffic with the specified origin network, destination network, or origin and destination network to the exclusion of all other networks.

In another embodiment, one parameter may be a time of day relative to a specific geographic location. Such a parameter may be based upon the time of day of the target network location. Alternatively, the time of day designation may be based on the location of the device that will be accessing the target network location. In yet another embodiment, the time of day may be based on a specific time zone, such as Greenwich Mean Time. Further yet, various target locations may shift between zones based on time of day. For example, a target location may be part of a first zone during AM hours and part of a different zone during PM hours.

In another embodiment, a user may assign a specific URL to a specific zone as one of the parameters. In one embodiment, a specific URL may be the entire designated zone. Such a single URL zone may be useful for streaming services that deliver a massive amount of content.

In another embodiment, a user may assign specific content to a specific zone. In one embodiment, a specific designation of content may be the entire designated zone. For example, the user may assign all files with a particular extension (.mp3) or even all files of a general type (all types of video files) to be designated as traffic for a dedicated zone. Such a single content zone may be useful for streaming services that deliver a massive amount of content.

In another embodiment, a user may assign a specific set of target locations based upon ownership of the target locations to a specific zone. In one embodiment, a specific set of target locations may all be owned by a single entity (e.g., all network target locations owned by a conglomerate corporation) and then may be designated as the entire designated zone.

In another embodiment, a user may assign a specific set of target locations based upon geographic locations of the target locations to a specific zone. In one embodiment, a specific set of target locations may all be within a single geographic region (e.g., all network target locations within North America or within Delaware) and then may be designated as the entire designated zone.

In another embodiment, a user may assign a specific set of target locations based upon designation of any manner of previous interaction of the target locations to a specific zone. In one embodiment, a specific set of target locations may all be known network locations (e.g., target locations previously browsed to) and then may be designated as the entire designated zone.

In another embodiment, a user may assign a specific set of target locations based upon designation of usage of the target locations to a specific zone. In one embodiment, a specific set of target locations may all be known network locations that have been used to a large degree (e.g., target locations often browsed to) and then may be designated as the entire designated zone.

In another embodiment, a user may assign a specific set of target locations based upon designation of current network connectivity parameters. In one embodiment, a specific set of target locations may all be known network locations (e.g., target locations previously browsed to and used for large data transfer) and then may be designated as being part of a zone based on whether the device being used for browsing is connected to a network through a Wi-Fi connection, a cellular connection, a dial-up modem connection, or the like.

The various parameters as discussed above may be combined as a group of two or more parameters to establish various zones as a user may loop back at step 506 to select secondary, tertiary, etc., parameters. For example, additional selections at step 506 may include additional parameters of a similar type (8 am-12 pm and 1 pm-5 pm) or of a dissimilar type (8 am-5 pm and .gov) or any combination of any of the parameters discussed herein.

At step 512, the computing device may engage in communicating data to and/or from at least one other computing device coupled to the local computing device through a computer network. As data is communicated, a decision step at 514 determines whether or not the communication is through the established zone and thereby part of an accepted subset of computing devices that can utilize the specifically established private encrypted communication channel associated with the established zone. If the answer to the query at step 514 is yes, then the computing device allows communication using the private encrypted channel with the remote computing device at step 516. After this, the method may end or repeat on an as needed basis.

If the answer to the query at step 512 is no, then the method moves to step 518 where the local computing device will reject the communication as being part of the private encrypted communication channel. Further, at step 518, access to data that is already part of the zone associated with the private encrypted communication channel will be restricted. Further still, the communication determined to be outside of the zone may be redirected through a communication channel other than the private encrypted communication channel associated with the zone at step 518. After this, the method may end or repeat on an as needed basis.

As skilled artisan understands that the method and algorithm shown in FIG. 5 may include more steps than those shown and aspects of the inventive subject matter may be accomplished with fewer than all of the steps shown in FIG. 5. Further, the steps may not necessarily be required to be accomplished in the order shown.

FIG. 6 is a diagram illustrating elements or components that may be present in a computer device or system configured to implement a method, process, function, or operation in accordance with an embodiment of the information disclosed herein. It may include the system, apparatus, methods, processes, functions, and/or operations for enabling efficient configuration and presentation of a user interface to a user, based on the user's previous behavior, may be wholly or partially implemented in the form of a set of instructions executed by one or more programmed computer processors, such as a central processing unit (CPU) or microprocessor. Such processors may be incorporated in an apparatus, server, client or other computing or data processing device operated by, or in communication with, other components of the system. FIG. 6 illustrates elements or components that may be present in a computer device or system 600 configured to implement a method, process, function, or operation in accordance with an embodiment. The subsystems shown in FIG. 6 are interconnected via a system bus 602. Additional subsystems include a printer 604, a keyboard 606, a fixed disk 608, and a monitor 610, which is coupled to a display adapter 612. Peripherals and input/output (I/O) devices, which couple to an I/O controller 614, can be connected to the computer system by any number of means known in the art, such as a serial port 616. For example, the serial port 616 or an external interface 618 can be utilized to connect the computer device 600 to additional devices and/or systems not shown in FIG. 6, including a wide area network (such as the Internet), a mouse input device, and/or a scanner. The interconnection via the system bus 602 allows one or more processors 620 to: communicate with each subsystem, control the execution of instructions that may be stored in a system memory 622 and/or the fixed disk 608, and to exchange information between subsystems. The system memory 622 and/or the fixed disk 608 may represent any tangible computer-readable medium.

The systems and methods disclosed can be implemented in the form of control logic using computer software in a modular or integrated manner. Based on the disclosure and information provided herein, a person of ordinary skill in the art will know and appreciate other ways and/or methods to implement the present disclosure using hardware and a combination of hardware and software.

Any of the software components, processes or functions described in this application may be implemented as software code to be executed by a processor using any suitable computer language (e.g., C, Go, Rust, Python, PHP, and the like) and any conventional, object-oriented, or other techniques. The software code may be stored as a series of instructions or commands on: a computer readable medium, such as a random access memory (RAM), or a read only memory (ROM); a magnetic medium, such as a hard-drive or a floppy disk; or an optical medium such as a CD-ROM. Any such computer readable medium may reside on or within a single computational apparatus, and may be present on or within different pieces of computational apparatus within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values are merely intended to serve as a shorthand method of referring individually to each separate value inclusively falling within the range, unless otherwise indicated, and each separate value is incorporated into the specification as if it were individually recited. All methods described can be performed in any suitable order unless otherwise indicated or clearly contradicted by context. The use of any and all examples, or exemplary language (e.g., “such as”) provided herein, is intended merely to better illuminate embodiments and does not pose a limitation to the scope of the disclosure unless otherwise claimed. No language in the specification should be construed as indicating any non-claimed element as essential to each embodiment of the present disclosure.

Different arrangements of the components depicted in the drawings or described above, as well as components and steps not shown or described, are possible. Similarly, some features and sub-combinations are useful and may be employed without reference to other features and sub-combinations. Embodiments have been described for illustrative and not restrictive purposes, and alternative embodiments will become apparent to readers of this patent. Accordingly, the present subject matter is not limited to the embodiments described above or depicted in the drawings, and various embodiments and modifications can be made without departing from the scope of the claims below.

While the subject matter discussed herein is susceptible to various modifications and alternative constructions, certain illustrated embodiments thereof are shown in the drawings and have been described above in detail. It should be understood, however, that there is no intention to limit the claims to the specific forms disclosed but, on the contrary, the intention is to cover all modifications, alternative constructions, and equivalents falling within the spirit and scope of the claims.

What is claimed is:

1. A computing device, comprising:
a processor configured to execute instructions stored in a memory;
a communication module coupled to the processor and configured to communicate with one or more external computing devices through a computer network;
a browser module stored in the memory and configured to be executed by the processor and configured to establish a communication link to at least one of the one or more external computing devices using the communication module; and
a zone control module stored in the memory and controlled by the browser module and configured to establish at least one zone of control for isolating communications coordinated by the browsing module within the established zone of control, the establishment based on at least one parameter corresponding to data in the communications received from the one or more external computing devices.

2. The computing device of claim 1, wherein the communication link comprises a virtual private network communication link.

3. The computing device of claim 1, wherein the communication link comprises an encrypted communication link.

4. The computing device of claim 1, wherein the at least one parameter comprises a time of receipt of the data from the one or more external computing devices.

5. The computing device of claim 1, wherein the at least one parameter comprises a top-level domain of the one or more external computing devices.

6. The computing device of claim 1, wherein the at least one parameter comprises a uniform resource locator of the one or more external computing devices.

7. The computing device of claim 1, wherein the at least one parameter comprises a type of content corresponding to the data received from the one or more external computing devices.

8. The computing device of claim 1, wherein the at least one parameter comprises a user-generated customized distinction among the one or more external computing devices.

9. The computing device of claim 1, wherein the at least one parameter comprises a geographic location of the one or more external computing devices.

10. The computing device of claim 1, further comprising a cache memory exclusively associated with the zone of control and configured to store data associated with communications within the zone of control.

11. A computing system, comprising:
a first computing device configured to communicate data through a computer network;
a second computing device configured to communicate with the first computing device through the computer network, the second computing device further comprising:
a processor configured to execute instructions stored in a memory;
a communication module coupled to the processor and configured to facilitate communications with the second computing device through the computer network;
a browser module stored in the memory and configured to be executed by the processor and configured to establish a communication link to the second computing device using the communication module; and
a zone control module stored in the memory and controlled by the browser module and configured to establish at least one zone of control for isolating communications coordinated by the browsing module within the established zone of control, the establishment based on at least one parameter corresponding to data in the communications received from the one or more external computing devices.

12. The computer system of claim 11, wherein the second computing device comprises a mobile computing device.

13. The computer system of claim 11, wherein the first computing device comprises a server computing device.

14. The computer system of claim 11, further comprising a third computing device configured to communicate with the second computing device outside of the zone of control.

15. The computer system of claim 11, further comprising proxy server computing device coupled between the first computing device and the second computing device and within the zone of control.

16. The computer system of claim 11, further comprising a third computing device that is within a second zone of control such that the second zone of control isolates communications coordinated by the browsing module that occur outside of the second zone of control and restricts other computing devices outside of the second zone of control from accessing data generated by the communications within the second zone of control without impacting communications in the first zone of control.

17. A computer-based method, comprising:
instantiating a browser having a private encrypted communication channel;
establishing at least one zone of control having at least one parameter associated with received data from at least one external computing device, the zone of control associated with the instantiated browser;
isolating communications coordinated by the instantiated browser that occur outside of the at least one zone of control from communication that occur with the zone of control.

18. The method of claim 17, further comprising instantiating a second browser to coordinate communication outside of the zone of control.

19. The method of claim 17, further comprising storing data from within the zone of control in an exclusive isolated memory cache associated with the zone of control.

20. The method of claim 17, further comprising restricting the data coordinated by the instantiated browser within the zone of control from access by communication or computation occurring outside of the zone of control without impacting communications outside of the zone of control.
